(19) United States
(12) Patent Application Publication
(10) Pub. No.: US 2014/0366839 A1
(43) Pub. Date: Dec. 18, 2014

(54) Transient Event Fuel Apportionment for Multi Fuel Engine System

(71) Applicant: Caterpillar Motoren GmbH & Co. KG., Kiel (DE)

(72) Inventors: Arvind Sivasubramanian, Peoria, IL (US); Christopher F. Gallmeyer, Peoria, IL (US)

(21) Appl. No.: 13/919,184

(22) Filed: Jun. 17, 2013

(51) Int. Cl. F02D 41/00

(52) U.S. Cl. CPC F02D 41/0025
USPC 123/352

(57) ABSTRACT

A method for controlling fuel flow in a multi fuel engine during transient events is disclosed. A specified fuel substitution ratio may be used for apportioning multiple fuels available for providing power to the multi fuel engine to provide input power for operating the engine at a desired engine speed. When a transient event occurs, such as a significant change in the desired engine speed or the load on the engine, a transient event fuel substitution ratio may used instead of the specified fuel substitution ratio to achieve a desired engine response to the event. The transient event may be detected based on, for example, the change in input power or engine speed caused by the event. The transient event fuel substitution ratio may be specified, or may be calculated based on a knock limit air fuel ratio or other factors.

### TECHNICAL FIELD

The present disclosure relates generally to multi fuel engines capable of operating with liquid fuel, with gaseous fuel and with a mixture of liquid and gaseous fuels, and more particularly, to methods and systems for controlling the apportionment of the multiple fuels to the multi fuel engine to meet the input power demand with a desired mixture of the multiple fuels.

### BACKGROUND

A multi fuel engine refers generically to any type of engine, boiler, heater or other fuel-burning device which is designed to burn multiple types of fuels in its operation. Multi fuel engines have application in diverse areas to meet particular operational needs in the operating environment. For example, a common use of multi fuel engines is in military vehicles so that vehicles in various deployment locations may run a wide range of alternative fuels such as gasoline, diesel or aviation fuel. In combat settings, for example, enemy action or unit isolation may limit the available fuel supply and personnel may need to resort the type of fuel available for usage from enemy and civilian sources. Multi fuel engines are also desirable where cheaper fuel sources, such as natural gas, are available, but an alternative or secondary fuel, such as diesel fuel, is needed for performance reasons (e.g., faster reaction to short term load demand), as a backup in the event of an interruption in the supply of the primary fuel source, or for other operational or engine performance conditions.

A multi fuel engine typically operates with a specified mixture of the available fuels. Where a liquid-only fuel mixture is specified, a liquid fuel, such as diesel fuel, gasoline or other liquid hydrocarbon fuel, is injected directly into an engine cylinder or a pre-combustion chamber as the sole source of energy during combustion. When a liquid and gaseous fuel mixture is specified, a gaseous fuel, such as natural gas, methane, hexane, pentane or any other appropriate gaseous hydrocarbon fuel, may be mixed with air in an intake port of a cylinder and a small amount or pilot amount of liquid fuel, such as diesel fuel, is injected into the cylinder or the pre-combustion chamber in an amount according to a specified substitution ratio in order to ignite the mixture of air and gaseous fuel.

A typical engine speed controller has one controller that acts on speed error to set a fuel rate. For engines that can run on multiple fuels, it is required to set multiple fuel rates based on the fuel fraction or desired ratio of fuels. For example, it may be desired to run a multi fuel engine on a mixture of 80% natural gas and 20% diesel. However, typical speed controllers (usually proportional-integral controllers, commonly called PI controllers) can only set a fuel rate for a single fuel. The normal way to deal with a multi fuel engine is to have each PI controller set an individual fuel rate for the corresponding fuel while ignoring the fact that there are other fuels supplying power to the engine. The fuel rates are set as if the other fuels do not exist. After the individual fuel rates are set by the PI controllers, a complicated switching strategy manages the multiple fuel rates, and selects a composite fuel flow based on the specified fuel mixture. The selected composite fuel flow accounts for the availability of the other fuels. If a specific fraction of fuel is desired, such as the 80% nature gas, 20% diesel fuel mixture discussed above, the switching strategy will output multiple fuel flow rates. In this case, separate control signals will be output to the flow control devices for natural gas and diesel fuel to create the fuel flows of each fuel that are necessary for the composite fuel flow. The disadvantages of this type of control structure include the significant amount of design time and effort required for multiple PI controllers and the complexity of the switching strategy to ensure that the overall design is robust and responsive to changes in the input power requirements.

During normal steady state operation of the multi fuel engines, the specified fuel substitution ratio is maintained to provide the composite fuel flow while the engine speed remains steady. When a transient event occurs requiring more fuel and, consequently more power, to be provided to engine, such as when the requested engine speed increases or when the torque on the engine increases, the controller will attempt to maintain the specified fuel substitution ratio even during the transient event. That is, the controller will attempt to add as much extra of each fuel necessary to provide the required input power to the engine while maintaining the fuel substitution ratio. However, practical limits can exist as to how much the fuel flow may be increased without encountering other operational issues. For example, increasing the fluid flow of natural gas too much can cause the air-fuel ratio (AFR) to become too rich if the air flow cannot be increased quickly enough to keep up with the increase flow of natural gas. Eventually, the excess natural gas can cause knocking in the engine. Similarly, supplying too much of a liquid fuel, such as diesel fuel, to the combustion chamber can cause smoke in the engine exhaust due to non-combustion of a portion of the liquid fuel.

In view of these conditions, a need exists for an improved multi fuel engine control strategy that simplifies the process for determining the fuel flow rates for the various fuels available to provide power to the engine. A further need exists for the multi fuel engine control strategy to adjust the fuel substitution ratio during transient events to provide the necessary power to the engine without causing secondary operating issues within the engine.

### SUMMARY OF THE DISCLOSURE

In one aspect of the present disclosure, a method for controlling fuel flow in a multi fuel engine during a transient event is disclosed. The method may include receiving a specified fuel substitution ratio for apportioning a plurality of fuels available for providing power to the multi fuel engine to provide an input power for operating the multi fuel engine at a desired engine speed, determining whether the transient event is occurring at the multi fuel engine, and outputting a fuel flow rate for each of the plurality of fuels to a corresponding actuator of a fluid flow control device for the one of the plurality of fuels to cause the corresponding actuator to provide the one of the plurality of fuels to the multi fuel engine according to the specified fuel substitution ratio in response to determining that the transient event is not occurring. The method may further include outputting a transient event fuel flow rate for each of the plurality of fuels to the corresponding actuator of the fluid flow control device for the one of the plurality of fuels to cause the corresponding actuator to provide the one of the plurality of fuels to the multi fuel engine according to a transient event fuel substitution ratio in response to determining that the transient event is occurring.

In another aspect of the present disclosure, an engine speed control system for a multi fuel engine is disclosed. The engine speed control system may include an engine speed control configured to output an engine speed control signal indicating a desired engine speed, a plurality of actuators, wherein each of the plurality of actuators corresponds to a fluid flow control device for one of a plurality of fuels available for providing power to the multi fuel engine by causing a flow of the corresponding one of the plurality of fuels to the multi fuel engine, and a controller operatively connected to the engine speed control and the plurality of actuators. The controller may be configured to store a specified fuel substitution ratio for apportioning the plurality of fuels to the multi fuel engine, to receive the engine speed control signal from the engine speed control, to determine an input power for operating the multi fuel engine at the desired engine speed, and to determine whether a transient event is occurring at the multi fuel engine. The controller may also be configured to output a fuel flow rate for each of the plurality of fuels to the one of the plurality of actuators of the fluid flow control device for the one of the plurality of fuels to cause the one of the plurality of actuators to provide the one of the plurality of fuels to the multi fuel engine according to the specified fuel substitution ratio in response to determining that the transient event is not occurring, and to output a transient event fuel flow rate for each of the plurality of fuels to the one of the plurality of actuators of the fluid flow control device for the one of the plurality of fuels to cause the one of the plurality of actuators to provide the one of the plurality of fuels to the multi fuel engine according to a transient event fuel substitution ratio in response to determining that the transient event is occurring.

Additional aspects are defined by the claims of this patent.

### BRIEF DESCRIPTION OF THE DRAWINGS

FIG. 1 is a schematic view of an exemplary multi fuel engine system in accordance with the present disclosure;

FIG. 2 is a schematic illustration of an exemplary electronic control unit and control components that may be implemented in the exemplary multi fuel engine system of FIG. 1;

FIG. 3 is a schematic illustration of an exemplary fuel apportionment control strategy for the multi fuel engine system of FIG. 1;

FIG. 4 is a flowchart of an exemplary fuel apportionment control routine that may be implemented in the multi fuel engine system of FIG. 1; and

FIG. 5 is a flowchart of an exemplary transient event fuel apportionment control routine that may be implemented in the multi fuel engine system of FIG. 1.

### DETAILED DESCRIPTION

Although the following text sets forth a detailed description of numerous different embodiments of the present disclosure, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term is expressly defined in this patent using the sentence “As used herein, the term “______” is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112(f).

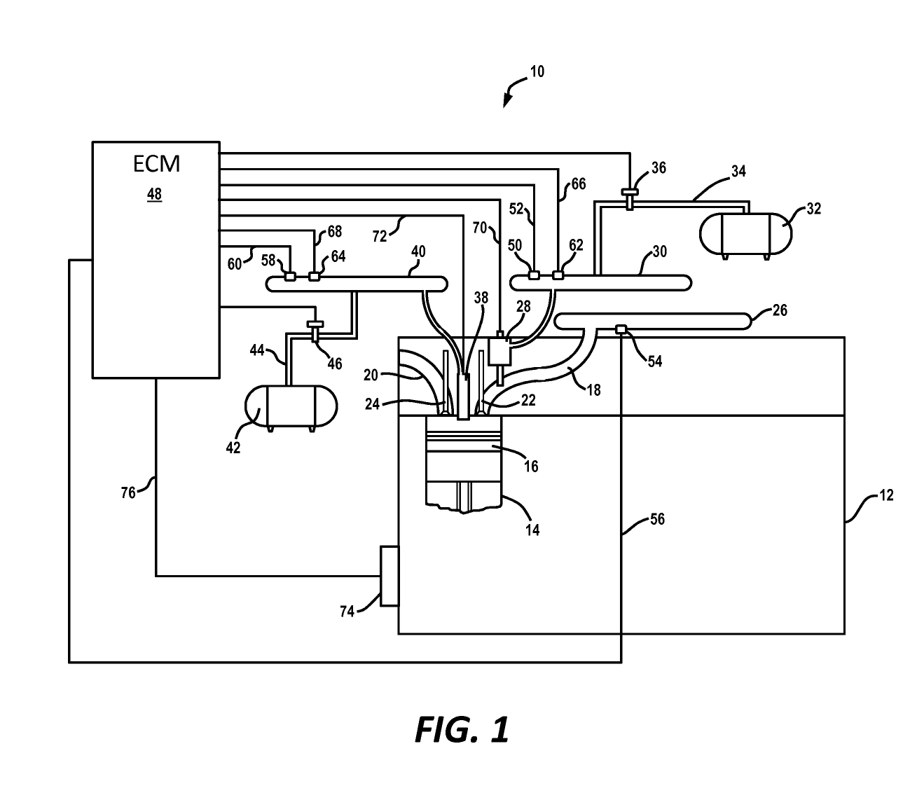

Referring to the drawings, FIG. 1 depicts an exemplary multi fuel engine system 10 that may include an engine 12 with a representative cylinder 14 of a plurality of cylinders 14 implemented in the engine 12. Although only one cylinder 14 is shown, it is recognized that the actual number of cylinders 14 of the engine 12 could vary and that the engine 12 could be of the in-line type, V-type, or even a rotary type engine. A piston 16 is positioned for displacement within the cylinder 14, and the cylinder 14 includes an intake port 18, an exhaust port 20, and an intake valve 22 and exhaust valve 24 regulating the fluid communication between the cylinder 14 and the intake port 18 and the exhaust port 20, respectively. The intake port 18 receives air from an air intake manifold 26 to which intake air travels after passing through, for example, an air filter (not shown) and turbo charger (not shown). A gaseous fuel admission valve 28 of a type commonly known in the art is positioned between a gaseous fuel manifold 30 at an upstream side and the intake port 18 at a downstream side. A nozzle portion of valve 28 may extend into the intake port 18 for delivering gaseous fuel thereto and mixing with the air from the air intake manifold 26. The gaseous fuel manifold 30 is connected to a gaseous fuel source 32 by a fuel path 34, and a solenoid operated gaseous fuel shut off valve 36 may be positioned along the fuel path 34. The gaseous fuel source 32 may provide any appropriate gaseous fuel that may be used in the multi fuel engine 12, such as natural gas, methane, hexane, pentane or any other gaseous hydrocarbon fuel. Although not shown, it is recognized that such a system might typically include a balance regulator positioned between the gaseous fuel source 32 and the gaseous fuel manifold 30 for regulating the gaseous fuel pressure at the upstream side of the gaseous fuel admission valve 28.

The engine 12 may further include a liquid fuel injector 38, such as an electronic unit injector, for injecting liquid fuel, such as diesel fuel, into the cylinder 14. The liquid fuel may be provided to the fuel injector 38 via a common rail 40 supplying each of the cylinders 14 of the engine 12 with pressurized liquid fuel transmitted to the common rail 40 from a pressurized liquid fuel source 42 via a liquid fuel path 44. A solenoid operated liquid fuel shut off valve 46 may be positioned along the liquid fuel path 44 to cut off the flow of liquid fuel if necessary. The exhaust port 20 fluidly connects the cylinder 14 to an emissions portion (not shown) of the multi fuel engine system 10 to discharge the exhaust created by the combustion of the fuels from the cylinder 14.

An electronic control module (ECM) 48 of the multi fuel engine system 10 may be connected to a gaseous fuel pressure sensor 50 via a conductive path 52, to an intake air pressure sensor 54 via a conductive path 56, and to a liquid fuel pressure sensor 58 via a conductive path 60 for receiving pressure indicative signals from the sensors 50, 54, 58. Such pressure sensors 50, 54, 58 are well known in the art and therefore a detailed description of the sensors 50, 54, 58 is not included herein. Temperature sensors 62, 64 are also provided in the gaseous fuel manifold 30 and the common rail 40, respectively, to provide temperature indicative signals to the ECM 48 via conductive paths 66, 68. The ECM 48 is connected for controlling the gaseous fuel admission valve 28 by a conductive path 70 and is also connected for controlling the fuel injector 38 by a conductive path 72. In this regard it is known to include driver circuitry or software within the ECM 48 for delivering current control signals to the gaseous fuel admission valve 28 and the fuel injector 38 to control the flow rates of the corresponding fuels there through. However, it is recognized that such driver circuitry could be implemented separate from, but connected to, the ECM 48. An engine speed sensor 74 associated with a camshaft or other component of the engine 12 from which the engine speed may be determined may also be connected to the ECM 48 via conductive path 76 for delivering engine speed indicative signals thereto.

The multi fuel engine system 10 as shown can operate in a liquid fuel mode or a multi fuel mode. In the liquid fuel mode, the gaseous fuel admission valve 28 remains closed while pressurized liquid fuel is injected into the engine cylinder 14 by the fuel injector 38 as the sole source of fuel energy during combustion. In the multi fuel mode, the gaseous fuel from the gaseous fuel source 32 is discharged into the intake port 18 by the gaseous fuel admission valve 28 and mixed with air from air intake manifold 26, and a small amount or pilot amount of the pressurized liquid fuel is injected into cylinder 14 at the fuel injector 38 in order to ignite the mixture of air and gaseous fuel. Those skilled in the art will understand that the configuration of the multi fuel engine system 10 shown in FIG. 1 and described herein is exemplary only, and other configurations are contemplated for implementation of the multi fuel engine control strategy in accordance with the present disclosure. For example, the multi fuel engine system 10 may be configured to be powered by additional types of gaseous and liquid fuels, and the multi fuel engine control strategy may be configured to allow specification of substitution ratios for apportioning the input power required by the engine 12 between the available fuels.

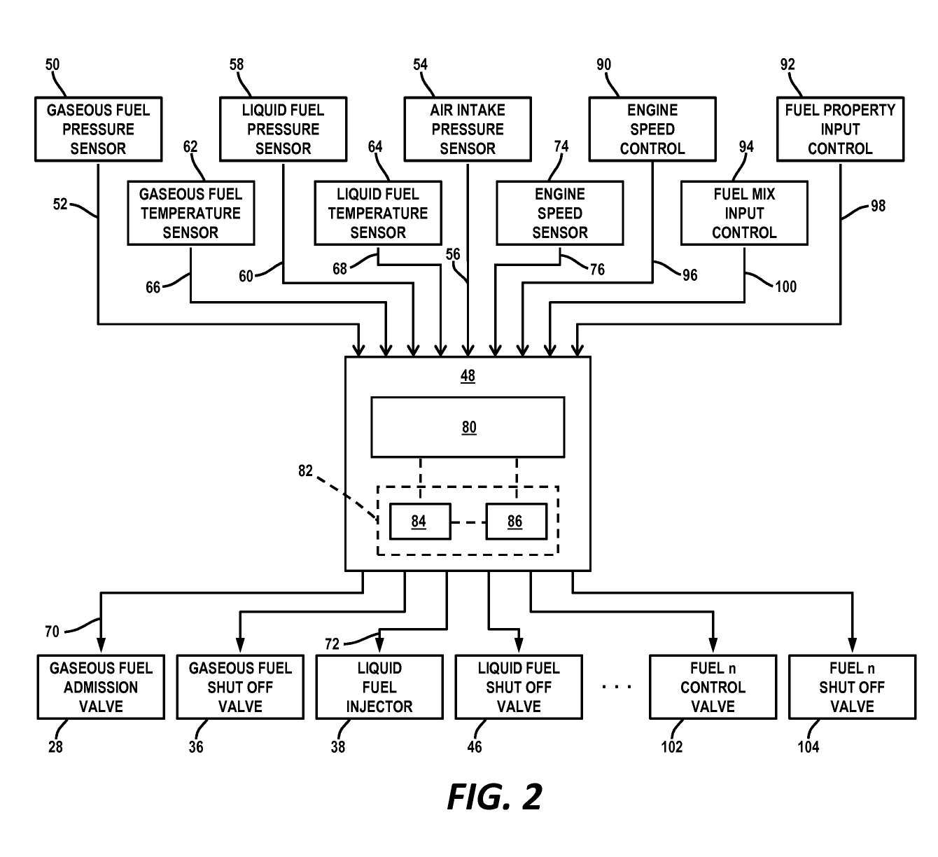

FIG. 2 illustrates one exemplary configuration of the ECM 48 that may be implemented in the multi fuel engine system 10 to control the operation of the engine 12 and the apportionment of fuels to provide the required power to the engine 12, and, if desired, to control the operations of other systems that are integrated with the multi fuel engine system 10. The ECM 48 may include a microprocessor 80 for executing specified programs that control and monitor various functions associated with the system 10. The microprocessor 80 includes a memory 82, such as read only memory (ROM) 84, for storing a program or programs, and a random access memory (RAM) 86 which serves as a working memory area for use in executing the program(s) stored in the memory 82. Although the microprocessor 80 is shown, it is also possible and contemplated to use other electronic components such as a microcontroller, an ASIC (application specific integrated circuit) chip, or any other integrated circuit device.

The ECM 48 electrically connects to the control elements of the multi fuel engine system 10, as well as various input devices for commanding the operation of the engine 12 and monitoring its performance. As a result, the ECM 48 may be electrically connected to the pressure sensors 50, 54, 58, temperature sensors 62, 64 and engine speed sensor 74 as discussed above to receive parameter value indicative signals relating to the operating conditions of the engine 12. The ECM 48 may also be electrically connected to input devices such as, for example, an engine speed control 90, a fuel property input control 92 and a fuel mix input control 94 via conductive paths 96, 98, 100, respectively. An operator of the multi fuel engine system 10 may manipulate the controls 90, 92, 94 to generate and transmit control signals to the ECM 48 with commands for operating the engine 12 as desired to produce the necessary engine speed with a desired apportionment of the available fuels. The engine speed control 90 may be any type of input device allowing an operator to specify a speed at which the engine 12 should operate to provide the output necessary to perform a desired task. For example, the engine speed control 90 could be a gas pedal of a vehicle or excavating machine, a thrust lever of an airplane, or other appropriate input device for specifying the speed of the engine 12.

The fuel property input control 92 may be any appropriate input device allowing an operator, technician or other user of the multi fuel engine system 10 to input information regarding the properties of the fuels available for use by the system 10. The fuel property data input may include any data necessary for the system 10 to determine an amount of a fuel necessary for producing an amount of power in the engine 12 to meet a power requirement determined as discussed further below. Examples of fuel property data that may be specified for a fuel available to the engine 12 include the density or specific gravity of the fuel, the heat of combustion of the fuel expressed as, for example, a lower or higher heating value indicating the energy released by the fuel per unit of mass or volume, and the like. The fuel property input control 92 may be a computer terminal or other similar input device connected to the ECM 48 by the conductive path 98 and allowing a user to input the fuel property data and transmit the data to the ECM 48. In alternative embodiments, the fuel property input control 92 may be a remote computing device or computing system connected via a network to the conductive path 98 to transmit fuel property data to the multi fuel engine system 10 from a remote location, such as a central control center, managing the operation of the system 10 in conjunction with the ECM 48. As a further alternative, the fuel property input control 92 may be an external storage device, such as a magnetic, optical or solid state storage device, on which the fuel property data is stored and downloaded to the ECM 48 when the external storage device is connected to the conductive path 98. Further alternative devices for inputting fuel property data and transferring the data to the ECM 48 via the conductive path 98, which can be a direct connection or a wireless connection, will be apparent to those skilled in the art and are contemplated by the inventors as having use in multi fuel engine systems in accordance with the present disclosure.

The fuel mix input control 94 may be any appropriate input device allowing an operator, technician or other user of the multi fuel engine system 10 to input information regarding the apportionment of the fuels available for use by the system 10. The fuel mix data input at the fuel mix input control 94 may specify fuel substitution ratios or fractions for usage of each of the available fuels for meeting the desired engine speed input power necessary to operate the engine 12 at the engine speed specified at the engine speed control 90. For example, in a dual fuel engine operating with a gaseous fuel (e.g., natural gas) and a liquid fuel (e.g., diesel fuel), it may be desired to have the gaseous fuel provide 80% of the power requirement and have the liquid fuel provide the remaining 20% of the power requirement. In such a case, a substitution ratio of 20%, or 0.20, may be input at the fuel mix input control 94 and stored at the ECM 48 so that the liquid fuel will be substituted for the gaseous fuel and provide 20% of the power. Where more fuels are available, a fuel substitution ratio or fraction may be input for each fuel, with the individual substitution ratios totaling 100%, or 1.00, so that the power supplied by the individual fuels adds up to the total input power required for the engine 12. The fuel mix input control 94 may be a similar input device as those discussed above for the fuel property input control 92. In some embodiments, the input controls 92, 94 may be implemented in the same input device, such as a graphical user interface located within an operator station and having a series of screens allowing an operator to input the fuel property data and the fuel mix data.

The ECM 48 may also be electrically connect to actuators and transmit control signals to the actuators to cause the various elements of the multi fuel engine system 10 to operate. Consequently, actuators for fluid flow control devices such as the gaseous fuel admission valve 28, the liquid fuel injector 38 and the shut off valves 36, 46 may be connected to the ECM 48 and receive control signals from the ECM 48 to operate the corresponding valves 28, 36, 46 and the fuel injector 38 to control flow of the gaseous and liquid fuels. Alternate implementations of the system 10 may allow the engine 12 to be powered by additional fuels that may be available. In those implementations, an additional fuel control valve 102 and shut off valve 104 may be provided to control the flow of the additional fuels up to an n^{th} fuel used in the system 10.

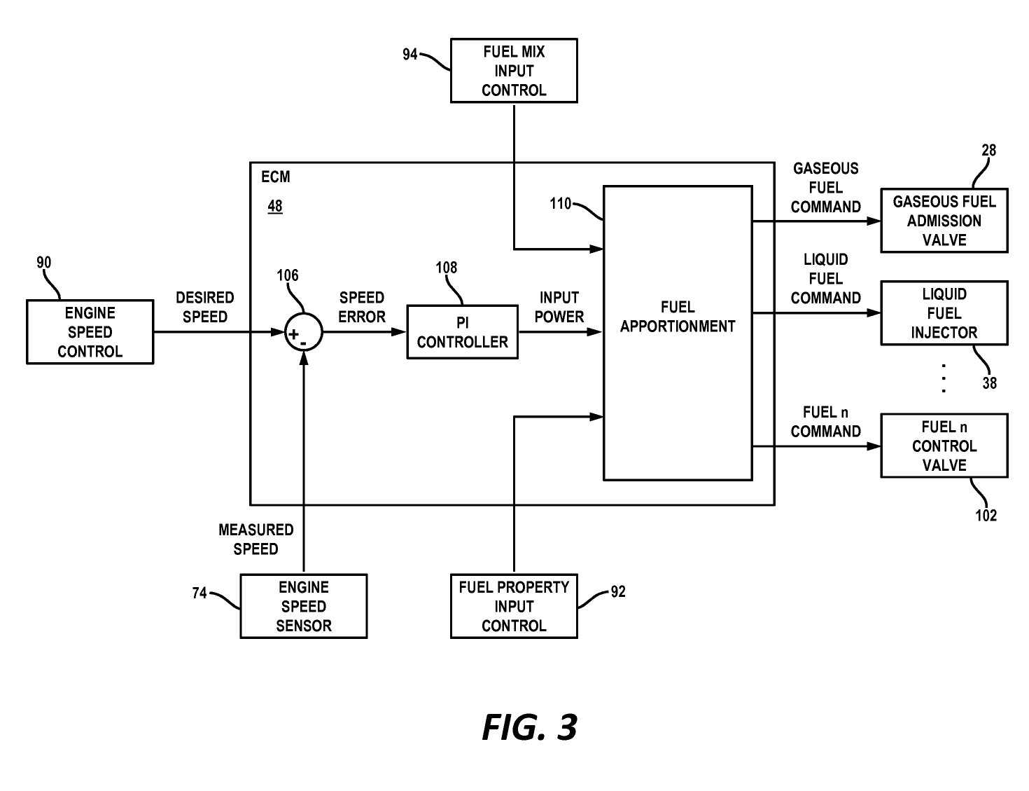

The ECM 48 and the accompanying control elements of FIG. 2 may be used to implement a fuel apportionment control strategy for the multi fuel engine system 10 that may provide the fuels to the engine 12 according to fuel mix data provided at the fuel mix input control 94. As can be seen from the schematic illustration of FIG. 3, the ECM 48 may be programmed with various control modules 106, 108, 110, for example, implementing the logic of the fuel apportionment control strategy. Though illustrated as being contained within a single ECM 48, the control modules 106, 108, 110 may be distributed across multiple processing elements of the multi fuel engine system 10 if necessary based on the requirements of a particular implementation. However, for the purpose of illustration, the ECM 48 will be discussed herein as a single processing element.

The fuel apportionment strategy may begin at an adder 106 of the ECM 48 that may perform a comparison of the desired speed for the engine 12 input at the engine speed control 90 and transmitted to the ECM 48 as an engine speed control signal to the current measure speed of the engine provided to the ECM 48 by the engine speed sensor 74 via a measured engine speed control signal. The adder 106 may subtract the measured speed of the engine 12 from the desired speed to arrive at a speed error. The speed error may have a positive value if the engine 12 is running slower than desired or a negative value if the engine 12 is running faster than necessary. The speed error may occur due to a change in the commanded speed at the engine speed control 90, or due to a change in the actual speed of the engine 12 as measured by the engine speed sensor 74 caused by an event such as a change in the load or torque on the engine 12.

The calculated speed error may be transmitted from the adder 106 to a single proportional-integral (PI) controller 108 of the ECM 48. The PI controller 108 may be configured to use the desired speed and the speed error to determine an input power to be provided by the available fuels to cause the actual or measured engine speed to increase or decrease toward the desired engine speed at a response rate specified during the configuration of the PI controller 108. The specific programming of the PI controller 108 to calculate the input power for the engine 12 is within the understanding of those skilled in the art, and a detailed discussion of PI controller programming methods is not provided herein. However, it was not known in previous multi fuel engine systems to provide a single PI controller 108 to calculate an input power for the engine prior to determining the apportionment of the available fuels as discussed herein. It should be noted also that the use of a PI controller is exemplary, and other types of controllers and control calculations capable of determining an input power for the engine 12 may be implemented in the fuel apportionment control strategy in accordance with the present disclosure.

The input power determined by the PI controller 108 for the engine 12 may be used, along with other input data, by a fuel apportionment module 110 to apportion the power demand between the available fuels. The fuel apportionment module 110 also uses data input at the fuel property input control 92 and the fuel mix input control 94, and stored in the memory 82 of the ECM 48, in determining the amount of each fuel to be provided to the engine 12. In one implementation, the fuel property data input for each of the n available fuel at the fuel property input control 92 includes a measure of the chemical energy content or fuel quality of the fuel in the form of a lower heating value LHVᵢ, a measure of the fuel's density, such as the mass density Dᵢ or specific gravity SGᵢ of the i^{th} fuel, and any other fuel property data necessary to accurately regulate the flow of the fuels per the calculated apportionment.

The fuel mix data entered at the fuel mix input control 94 indicates the portion of the input power to be provided by each of the n available fuels. To facilitate adaptability for use of additional or alternate fuels in the multi fuel engine 12, the system 10 may be configured to allow the operator to enter a fuel substitution ratio FSRᵢ at the fuel mix input control 94 for each of the n fuels. Each fuel substitution ratio FSRᵢ may have a value between 0.00 and 1.00 representing the portion of the required input power to be provided by the corresponding fuel. To ensure that 100% of the input power requirement is provided by the fuels, and that excess fuel is not provided to the engine 12, the ECM 48 and the fuel mix input control 94 may be configured to restrict entry of values of the fuel substitution ratio FSRᵢ to those satisfying the equation:

Σᵢ₌₁ⁿFSRᵢ=1 (1)

As will be discussed below, a value of the fuel substitution ratio FSRᵢ equal to 0.00 indicates that the i^{th} fuel will not be used to provide power to the engine 12, and a value of the fuel substitution ratio FSRᵢ equal to 1.00 indicates that the i^{th} fuel will provide 100% of the input power to the engine 12 without substitution of any of the other available fuels.

When the input power is transmitted to the fuel apportionment module 110 from the PI controller 108, the fuel apportionment module 110 retrieves the fuel property and fuel mix data necessary to apportion the available fuels. The fuel apportionment module 110 uses the data to determine a mass flow rate m′ᵢ for each fuel based on the following equation:

$${\dot{m}}_{i} = \frac{{FSR}_{i} \times Input Power}{{LHV}_{i}} \qquad ( 2 )$$

where FSRᵢ is the unitless fuel substitution ratio for the i^{th} fuel, Input Power is the commanded power transmitted from PI controller 108 having units of energy per unit of time, and LHVᵢ is the lower heat value for the i^{th} fuel having units of energy per unit of mass. Equation (2) yields the mass flow rate m′ᵢ in mass per unit of time required for each of the i fuels to provide the required portion of the commanded power to the engine 12.

After determining the mass flow rate m′ᵢ for each available fuel, the fuel apportionment module 110 formats commands for the actuators of the fuel flow control devices 28, 38, 102 to cause the devices to provide the required mass flow to the engine 12. The fuel apportionment module 110 may be configured to convert each mass flow rate m′ᵢ into a control signal that will cause the corresponding fuel flow control device 28, 38, 102 to output fuel at the appropriate rate. The conversions in the fuel apportionment module 110 may incorporate lookup tables, conversion equations utilizing additional fuel properties, or any other appropriate conversion logic necessary to generate the control signals. As shown in FIG. 3, the fuel apportionment module 110 may transmit a separate control signal to each of the fuel flow control devices 28, 38, 102. Consequently, a gaseous fuel command may be transmitted to the gaseous fuel admission valve 28 to cause the valve 28 to open to the position necessary to add the appropriate amount of gaseous fuel to the intake air in the intake port 18 and subsequently to the cylinder 14. Similarly, the liquid fuel command may be transmitted to the liquid fuel injector 38 to cause the injection of the required amount of liquid fuel into the combustion chamber of the cylinder 14. For each additional available fuel up to the n^{th} fuel, the fuel apportionment module 110 transmits a fuel command to the corresponding fuel control valve 102. For each fuel having a fuel substitution ratio FSRᵢ, and correspondingly a mass flow rate m′ᵢ, equal to zero, the fuel apportionment module 110 transmits a fuel command causing the corresponding fuel flow control device 28, 38, 102 to prevent fuel flow to the engine 12.

In the exemplary dual fuel engine 12, the engine 12 may primarily run on natural gas and have diesel fuel available as a backup or secondary fuel source to power the engine 12 or to provide a pilot amount of fuel to ignite the gaseous fuel and air mixture. In such dual fuel engines 12, the fuel apportionment control strategy may be modified to acknowledge the design of the engine 12 and the use of exactly two fuels to provide power to the engine 12. At the fuel property input control 92, an operator may input a lower heat valve LHV_{NG} and a specific gravity SG_{NG} for the natural gas supply, and a lower heat value LHV_{D} and a specific gravity SG_{D} for the diesel fuel among other relevant fuel property data. The fuel mix data entered at the fuel mix input control 94 indicates the portion of the input power to be provided by the natural gas and the diesel fuel. Where the engine 12 is designed for only two fuels, a single fuel substitution ratio FSR may be used to indicate the amount of the secondary fuel source to substitute for the primary fuel source. Consequently, in the exemplary natural gas/diesel fuel dual fuel engine 12, a fuel substitution ratio FSR equal to 20%, or 0.20, for example, may be specified at the fuel mix input control 94 to supply power to the engine 12 at an 80% natural gas/20% diesel fuel apportionment.

In the duel fuel engine example, the calculation of the mass flow rates m′ of the fuels performed at the fuel apportionment module 110 may also be modified to account for the use of two fuels and the input of a single fuel substitution ratio FSR. In this implementation, equation (2) may be modified into separate mass flow rate M′ equations for the primary and secondary fuels. The secondary diesel fuel mass flow rate m′_{D} may be calculated as follows:

$${\dot{m}}_{D} = \frac{FSR \times Input Power}{{LHV}_{D}} \qquad ( 3 )$$

The equation for determining the primary natural gas mass flow rate m′_{NG} may also utilize the single fuel substitution ratio FSR as follows:

$${\dot{m}}_{NG} = \frac{( 1 - FSR ) \times Input Power}{{LHV}_{NG}} \qquad ( 4 )$$

Using equations (3) and (4), the mass flow rates m′_{NG}, m′_{D} will yield 100% of the commanded input power output from the PI controller 108. Based on the mass flow rates m′_{NG}, m′_{D}, the fuel apportionment module 110 will generate the appropriate control signals and transmit the corresponding gaseous fuel commands and liquid fuel commands to the gaseous fuel admission valve 28 and the liquid fuel injector 38, respectively.

### INDUSTRIAL APPLICABILITY

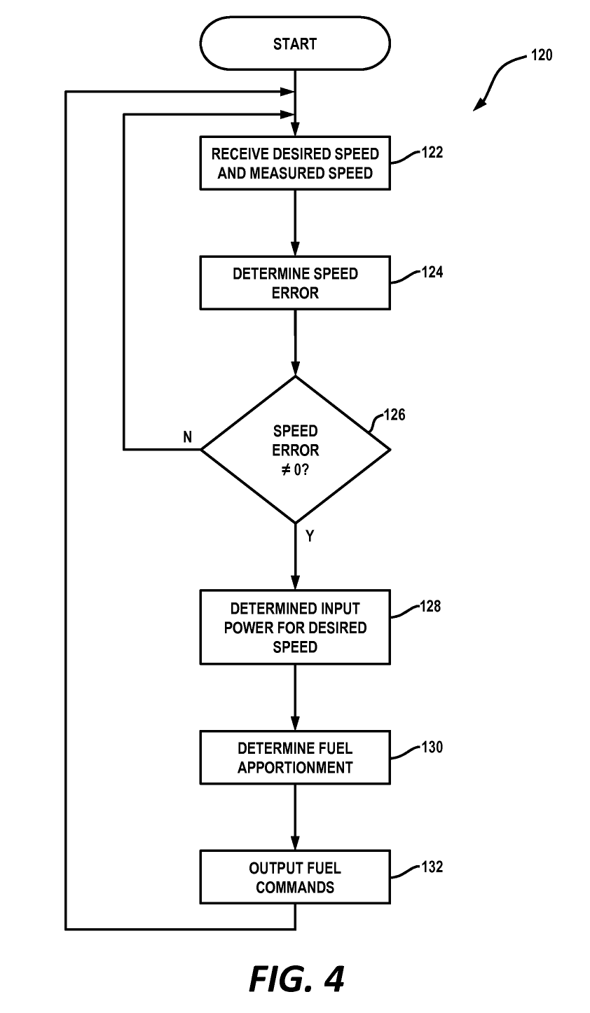

For proper operation of the multi fuel engine system 10 configured as described above, the ECM 48 may be programmed with a fuel apportionment routine 120 such as that illustrated in FIG. 4. The fuel apportionment routine 120 may begin a block 122 where the ECM 48 receives the control signal from the engine speed control 90 indicating the desired speed, and the engine speed indicative signal from the engine speed sensor 74 indicating the measured engine speed. Control then passes to a block 124 wherein the desired speed and the measured speed are input to the adder 106 to determine the engine speed error. The engine speed error determined by the adder 106 is output to the PI controller 108 at a block 126 to determine whether the desired and measured engine speeds are different such that the input power provided to the engine 12 by the available fuels must be recalculated.

If the desired speed matches the measured speed and the speed error is equal to zero at the block 126, it may not be necessary to change the input power to the engine 12 and control may pass back to the block 122 to continue receiving and evaluating the desired and measured engine speeds. In alternative embodiments, an amount of speed error may be acceptable so that a recalculation of the input power for the engine 12 is not required. In such cases, the ECM 48 may be configured with a range of speed error values that will cause control to be passed back to the block 122 without recalculating the input power for the engine 12. The speed error value range may be centered around a speed error value of zero, or may be offset from zero if a greater amount of tolerance exists for speed errors that have either positive values (i.e., the engine 12 is running too slow) or negative values (i.e., the engine 12 is running too fast).

If the ECM 48 determines that a non-zero speed error exists, or that the speed error is outside a range of acceptable values, control may pass to block 128 where the speed error is input to the PI controller 108 to determine the updated input power required to cause the engine 12 to operate at the desired engine speed as discussed above. After the updated input power is determined at the block 128, control passes to a block 130 where the updated input power is input to the fuel apportionment module 110 to determine the appropriate fuel apportionment based on the fuel property data input at the fuel property input control 92 and the fuel mix data input at the fuel mix input control 94. The fuel apportionment is determined using calculations such as those provided in equations (2)-(4) to arrive at the amount of each available fuel to be provided to the engine 12 to generate the input power required to operate the engine 12 at the desired engine speed. After determining the fuel apportionment, control passes to a block 132 where the fuel apportionment module 110 outputs fuel commands to each of the fuel flow control devices 28, 38, 102 of the engine 12, such as the gaseous fuel admission valve 28, the liquid fuel injector 38 and the fuel control valves 102, to cause the devices to provide the various fuels to the engine 12 at the appropriate rates. After transmitting the output commands, control passes back to the block 122 to continue monitoring the desired speed and the measured speed and adjusting the input power and fuel commands as necessary.

It will be apparent to those skilled in the art that the fuel apportionment routine 120 may be adapted to respond to the occurrence of conditions other than changes in the desired engine speed necessitating a change in the input power to be provided by the fuels available to the multi fuel engine 12. For example, changes in the load on the engine 12 may dictate corresponding adjustments to the input power required to operate the engine 12 even where the desired speed of the engine 12 remains constant. In many situations, load changes on the engine 12 are detectable based on corresponding changes in the measure engine speed (increased load=decreased engine speed and vice versa). In these situations, the load changes may be handled by the fuel apportionment routine 120 in the manner described above.

Alternatively, load variations may be handled in the multi fuel engine system 10 by including a load sensor (not shown) that is operatively coupled to the cam shaft, output shaft or other appropriate component to sense the load on the engine 12. The load sensor may be electrically connected to the ECM 48 by a conductive path (not shown) and transmit load indicative signals for the measured load that may be compared at comparator (not shown) or other appropriate module of the ECM 48 to a previously measured load value to determine if the load is changing. If the new measured load is increasing or decreasing, a separate PI controller (not shown), or the PI controller 108 adapted to respond to changes in speed and load, may determine a new input power required to operate the engine 12 at the desired engine speed with the measured load applied to the engine 12. After the new input power is determined, the fuel apportionment module 110 may operate in a similar manner as described above to apportion the available fuels and output the fuel commands.

The presently disclosed multi fuel engine system 10, including the fuel apportionment routine 120, determines the appropriate fuel apportionment to achieve a desired fuel mixture using only a single PI controller 108. The single PI controller 108 determines the input power required to operate the multi fuel engine 12 at a desired engine speed, and the fuel apportionment module 110 performs the mass flow calculations of equations (2)-(4) as necessary to apportion the input power between the available fuels. The present system 10 eliminates the complex switching logic and conflicts between multiple PI controllers each generating a fuel command for the corresponding fuels to supply 100% of the input power to the multi fuel engine that exist in previous multi fuel engine systems. This approach simplifies the process for configuring the ECM 48 to control the operation of the multi fuel engine 12.

In the disclosed multi fuel engine system 10 and other multi fuel engine systems utilizing other fuel apportionment strategies, the specified fuel substitution ratios FSRs are maintained as the multi fuel engines 12 operate. As discussed above, a specified fuel substitution ratio FSR may not provide an optimal mix of the available fuels during all operating conditions. During transient events, when the desired speed of, or the actual load on, the engine 12 changes substantially, the fuels may not be able to respond to the transient events due to limitations related to the properties or delivery methods of the fuels. In the example provided above, a turbo charger of the engine 12 may not be able to produce enough air flow in the air intake manifold 26 to keep the AFR below a predetermined knock limit AFR when the flow of gaseous fluid is increased at the gaseous fuel admission valve 28. In other implementations, responsiveness of the engine 12 to the transient event may be improved by increasing the proportion of a liquid fuel, such as diesel fuel, during the transient event.

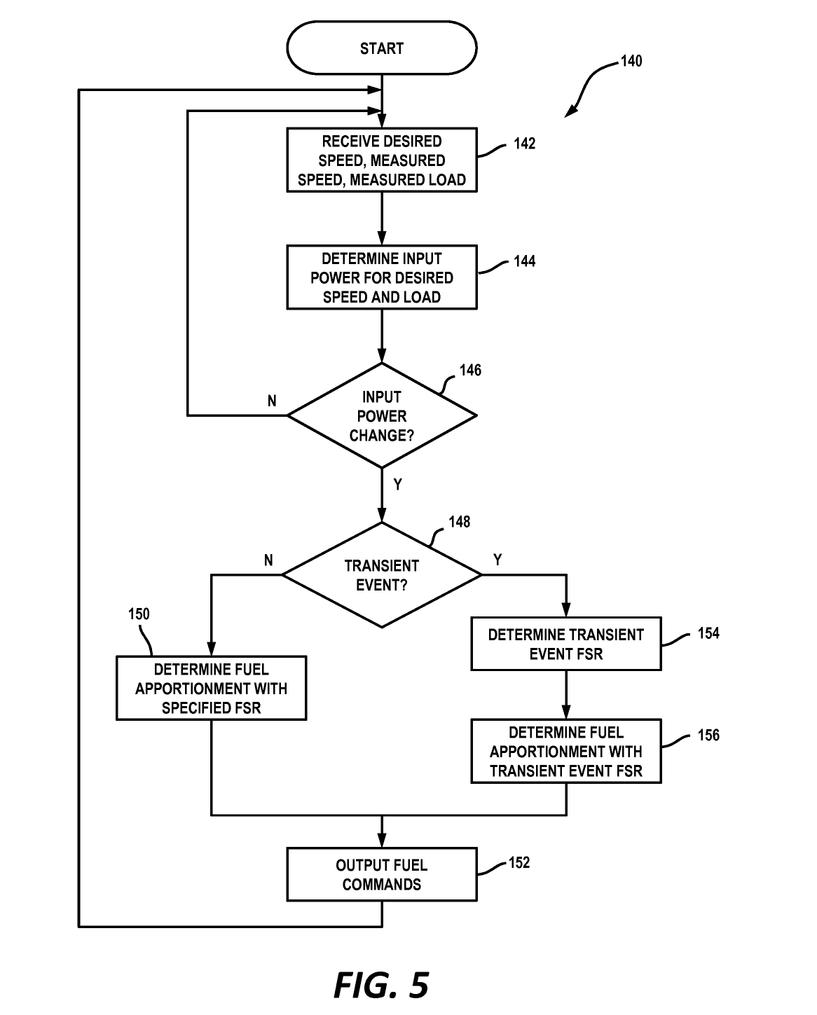

The performance of multi fuel engine systems 10 during transient events may be improved by implementing a transient event fuel apportionment routine 140 such as that shown in FIG. 5 within the fuel apportionment routine of the system 10, such as the routine 120 illustrated in FIG. 4 and discussed above. The routine 140 allows the multi fuel engine system 10 to temporarily operate under a modified fuel substitution ratio or ratios during the transient event, and subsequently return to the specified fuel substitution ratio at the end of the transient event or when the engine 12 can function appropriately using the specified fuel substitution ratio during the transient event. The transient event fuel apportionment routine 140 may begin at a block 142 where the ECM 48 receives the control signals from the engine speed control 90 indicating the desired speed, the engine speed indicative signal from the engine speed sensor 74 indicating the measured engine speed and, if necessary, the load indicative signals from the load sensor indicating the measure load on the engine 12.

After receiving the speed and load data, control may pass to a block 144 where the ECM 48 may determine the input power required to operate the engine 12 at the desired speed. In one implementation, the PI controller 108 may be configured to receive the measured load and use the measured load along with the desired speed and speed error to determine the input power required for the fuels. Alternatively, a separate controller, such as a further PI controller 108, a proportion-integral-derivative (PID) controller or other appropriate device or programming logic, may be provided to determine a load input power. The load input power may subsequently be combined with the speed input power calculated by the PI controller 108 to arrive at an overall input power to be used by the fuel apportionment module 110. Further alternative modules and strategies for determining the input power based on the desired speed and applied load will be apparent to those skilled in the art and are contemplated by the inventors as having use in transient event fuel apportionment routines in accordance with the present disclosure.

After the input power is determined at the block 144, control may pass to a block 146 wherein the ECM 48 determines whether the newly-calculated input power reflects a change from the input power currently being supplied to the engine 12. If the input power is not changing, the fuel apportionment routine 120 may continue providing fuel to the engine 12 with the current fuel apportionment according to the current fuel substitution ratio, which in most cases is the specified fuel substitute ratio. Where the input power is unchanged, control may pass back to the block 142 to continue receiving and evaluating the desired and measures speeds and the measured load. If the input power is changing, control may pass to a block 148 wherein the ECM 48 may determine whether a transient event is occurring. While the determination of the input power occurs before determining whether a change in the input power is occurring in the routine 140 as illustrated in FIG. 5 and described, those skilled in the art will understand that the ECM 48 may determine whether the input power requirement is changing before actually determining the new input power. For example, the speed error and/or a comparison of the measured load to the previously measured load may be evaluated to determine whether a change in the input power is necessary. If the evaluation indicates that the input power will not change, then the processing required to determine the input power requirement may be avoided by passing control back to the block 142.

When an input power change is required and control passes to the block 148, the ECM 48 determines if the change to the new input power requirement from the current input power constitutes the occurrence of a transient event. Transient events are typically associated with increases in the desired speed and/or the load on the engine 12 that require an increase in the input power provided by the fuels, but significant speed decreases or load reduction may also constitute transient events that may require divergence from the specified fuel substitution ratio FSR. Various strategies for determining the occurrence of a transient event may be implemented at the ECM 48. The transient event evaluation may be based on the engine speed, with the occurrence of a transient event being determined using the speed error and the engine speed change required to arrive at the desired engine speed commanded by the engine speed control 90. The ECM 48 may be configured with a predetermined transient event speed error value, and determine that a transient event is occurring when the gross speed error is greater than the transient event value. Alternatively, a transient event may be identified as occurring when a required engine speed percentage change in the engine speed required to transition from the measured engine speed to the desired engine speed exceeds an established threshold percentage change, such as a transient event engine speed percentage change. For example, a speed error that requires the measured engine speed to change by greater than 25% may be interpreted as a transient event.

In a further alternative transient event determination strategy, the ECM 48 may monitor the air fuel ratio AFR and determine that the air fuel ratio AFR is or will become too rich with gaseous fuel so that knocking may occur in the cylinders 14 as the speed of the engine 12 increases. If the ECM 48 determines that an actual or estimated air fuel ratio AFR is greater than a specified knock limit air fuel ratio AFR_{KL}, a transient event is occurring to cause the air fuel ratio AFR to become too rich. The air fuel ratio AFR used by the ECM 48 for comparison to the knock limit air fuel ratio AFR_{KL} may be determined by direct measurement of the current air fuel ratio AFR for the mixture in the intake port 18, or by calculation of the current air fuel ratio AFR based on direct measurements of properties of the gaseous fuel and the intake air, such as temperature, pressure and flow rate from the gaseous fuel admission valve 28 and the air intake manifold 26. Appropriate measurement equipment and calculations for determining the current air fuel ratio AFR based on measured properties of the gaseous fuel, the intake air and/or the fuel/air mixture will be apparent to those skilled in the art.

The ECM 48 may alternatively be configured to determine whether the knock limit air fuel ratio AFR_{KL} may be exceeded based on known operational parameters of the gaseous fuel admission valve 28 and the turbo charger or other source of pressurized air provided to the air intake manifold 26. In particular, the responsiveness of the pressurized air source may be known so that the ECM 48 may determine whether the source can supply the amount of pressurized air required to increase the air mass flow rate as necessary to provide the required input power at the specified fuel substitution ratio FSR. The ECM 48 would determine that a transient event is occurring if the intake air supply will be insufficient to maintain the air fuel ratio AFR below the knock limit air fuel ratio AFR_{KL}. Further alternative methods for determining the occurrence of a transient event will be apparent to those skilled in the art and are contemplated by the inventors as having use in multi fuel engine systems 10 in accordance with the present disclosure.

If the ECM 48 determines that a transient event is not occurring at the block 148, control may pass to a block 150 to determine the fuel apportionment based on the specified fuel substitution ratio(s) FSR in a similar manner as discussed above for the block 130 of the fuel apportionment routine 120. After the fuel apportionment is determined at the block 150, control may pass to a block 152 where the fuel apportionment module 110 outputs fuel commands to the gaseous fuel admission valve 28, the liquid fuel injector 38 and other fuel control valves 102 according to the fuel apportionment determined at the block 150. As the fuel commands are transmitted, control passes back to the block 142 to continue receiving the desired and measured speeds and measured load, and monitoring for the occurrence of speed errors, input power changes and occurrences of transient events.

If the ECM 48 determines that a transient event is occurring at the block 148, control may pass to a block 154 where the ECM 48 determines a transient event fuel substitution ratio FSR_{TE} for apportionment of the available fuels during the transient event. The transient event fuel substitution ratio FSR_{TE} may increase the substitution of the secondary fuel(s) for the primary gaseous fuel to ensure that the knock limit air fuel ratio AFR_{KL} is not exceeded and/or that the engine 12 has a desired level of responsiveness to the transient event while still providing the necessary input power with the increase in the secondary fuel(s). The ECM 48 may be configured with a predetermined transient event fuel substitution ratio FSR_{TE} that is used during each transient event. Consequently, in the dual fuel engine example, where the specified fuel substitution ratio FSR is 0.20, the transient event fuel substitution ratio FSR_{TE} may be set to 0.25, 0.50 or any other appropriate ratio that ensures that the air fuel ratio AFR will not exceed the knock limit air fuel ratio AFR_{KL} and/or that the engine 12 is sufficiently responsive to the transient event.

In alternative embodiments, the ECM 48 may be configured to determine the transient event fuel substitution ratio FSR_{TE} dynamically based on the required input power and the current operating conditions within the engine 12. For example, the pressurized air available through the air intake manifold 26 may be determined by the ECM 48 from appropriate sensor signals, and then used to calculate a knock limit mass flow rate m′_{KL} of the gaseous fuel that will result in the knock limit air fuel ratio AFR_{KL}. The mass flow rate equations (2) and (4) may be solved for the fuel substitution ratios FSR and used to calculate the transient event fuel substitution ratio FSR_{TE} as follows:

$$\begin{matrix}{FSR}_{TE} = \frac{{\dot{m}}_{KL} \times {LHV}_{i}}{Input Power} & ( 5 ) \\ {FSR}_{TE} = 1 - \frac{{\dot{m}}_{KL} \times {LHV}_{NG}}{Input Power} & ( 6 )\end{matrix}$$

The transient event fuel substitution ratio FSR determined by the appropriate equation (5) or (6) is that which will maintain the air fuel ratio AFR at or below the knock limit air fuel ratio AFR_{KL}. The calculated transient event fuel substitution ratio FSR_{TE} may then be used in determining the fuel apportionment in lieu of the specified fuel substitution ratio FSR in the dual fuel engine example. Where the engine 12 is configured to operate with more than two fuels, the fuel substitution ratios FSR; for the other fuels may be adjusted accordingly to reflect a reduction in the portion of the input power being provided by the primary or gaseous fuel. In the event that the transient event fuel substitution ratio FSR_{TE} would allow for less substitution of the secondary fuel(s) and an increase in primary fuel beyond that provided by the specified fuel substitution ratio FSR, the ECM 48 may be configured to override the calculated transient event fuel substitution ratio FSR_{TE} and set the value of the transient event fuel substitution ratio FSR_{TE} equal to the specified fuel substitution ratio FSR for apportioning the fuels to meet the input power requirement.

After the transient event fuel substitution ratio FSR_{TE} is determined at the block 154, control may pass to a block 156 where the fuel apportionment module 110 uses the transient event fuel substitution ratio FSR_{TE} to determine the fuel apportionment during the transient event. The processing at the fuel apportionment module 110 may be generally the same as at the block 150 and as described above using equations (2)-(4) with the transient event fuel substitution ratio FSR_{TE}. If necessary, however, the mass flow rate m′ or a particular fuel may be limited by a smoke limit mass flow rate m′_{SL} above which smoke will be produced in the engine exhaust due to incomplete combustion. The fuel apportionment module 110 may be configured to set the mass flow rate m′ at or below the smoke limit mass flow rate m′_{SL}. In this situation, the overall fuel apportionment may dictate fuel flow to the engine 12 that produces less power than the required input power determined at the PI controller 108 until sufficient air flow can be produced to allow the gaseous fuel to be increased without exceeding the knock limit air fuel ratio AFR_{KL}.

After the fuel apportionment is determined at the block 156, control may pass to the block 152 where the fuel apportionment module 110 outputs fuel commands to the gaseous fuel admission valve 28, the liquid fuel injector 38 and other fuel control valves 102 according to the fuel apportionment determined at the block 150. As the fuel commands are transmitted, control passes back to the block 142 to continue receiving the desired and measured speeds and measured load, and monitoring for the occurrence of speed errors, input power changes and occurrences of transient events. As the ECM 48 continues to cycle through the transient event fuel apportionment routine 140, the multi fuel engine 12 may continue to operate according to the transient event fuel substitution ratio FSR_{TE} until either the transient event ends or the specified fuel substitution ratio FSR can be used for fuel apportionment without exceeding the knock limit air fuel ratio AFR_{KL}.

The transient event fuel apportionment routine 140 provides temporary adjustments to the fuel apportionment during transient events to provide the power required to change the speed of the multi fuel engine 12 while avoiding adverse operating conditions such as knocking and smoke-filled exhaust. The transient event apportionment strategy may combine the advantages of a gaseous fuel engine, such as reduced operating costs due to the cheaper fuel costs, with the advantages of a liquid fuel engine, such as a diesel engine that may provide better transient event performance. The routine 140 may also be configured to detect and respond to transient events occurring for reasons other than matching the desired engine speed and adjusting to load changes. For example, a transient event may occur when piston damage causes engine knocking even at the steady state. To respond in these situations, the routine 140 may be configured to determine the occurrence of transient events based on the actual air fuel ratio AFR in the manner discussed above, and not solely based on adjusting to meet the desired engine speed. The modified configuration of the routine 140 may allow the ECM 48 to respond and automatically modify the fuel substitution ratio FSR even at an engine steady state to avoid engine knocking.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

What is claimed is:

1. A method for controlling fuel flow in a multi fuel engine during a transient event, comprising:
receiving a specified fuel substitution ratio for apportioning a plurality of fuels that are available for providing power to the multi fuel engine to provide an input power for operating the multi fuel engine at a desired engine speed;
determining whether the transient event is occurring at the multi fuel engine;
outputting a fuel flow rate for each of the plurality of fuels to a corresponding actuator of a fluid flow control device for the one of the plurality of fuels to cause the corresponding actuator to provide the one of the plurality of fuels to the multi fuel engine according to the specified fuel substitution ratio in response to determining that the transient event is not occurring; and
outputting a transient event fuel flow rate for each of the plurality of fuels to the corresponding actuator of the fluid flow control device for the one of the plurality of fuels to cause the corresponding actuator to provide the one of the plurality of fuels to the multi fuel engine according to a transient event fuel substitution ratio in response to determining that the transient event is occurring.

2. The method of claim 1, comprising:
determining whether the input power must change to operate the multi fuel engine at the desired engine speed before determining whether the transient event is occurring;
determining whether the transient event is occurring in response to determining that the input power must change; and
continuing outputting the fuel flow rate for each of the plurality of fuels according to a current fuel substitution ratio in response to determining that the input power is not changing.

3. The method of claim 1, wherein determining whether the transient event is occurring comprises:
receiving the desired engine speed;
determining a measured engine speed of the multi fuel engine;
determining a speed error equal to a difference between the desired engine speed and the measured engine speed;
comparing the speed error to a transient event speed error value; and
determining that the transient event is occurring if the speed error is greater than the transient event speed error value.

4. The method of claim 1, wherein determining whether the transient event is occurring comprises:
receiving the desired engine speed;
determining a measured engine speed of the multi fuel engine;
calculating a required engine speed percentage change required for the measured engine speed to be equal to the desired engine speed;
comparing the required engine speed percentage change to a transient event engine speed percentage change; and
determining that the transient event is occurring if the required engine speed percentage change is greater than the transient event engine speed percentage change.

5. The method of claim 1, wherein determining whether the transient event is occurring comprises:
receiving the desired engine speed;
determining the input power required to operate the multi fuel engine at the desired engine speed;
determining a current input power provided to the multi fuel engine by the plurality of fuels;
determining an input power change equal to a difference between the input power required to operate the multi fuel engine at the desired engine speed and the current input power;
comparing the input power change to a transient event gross input power change; and
determining that the transient event is occurring if the input power change is greater than the transient event gross input power change.

6. The method of claim 1, wherein determining whether the transient event is occurring comprises:
receiving the desired engine speed;
determining the input power required to operate the multi fuel engine at the desired engine speed;
determining a current input power provided to the multi fuel engine by the plurality of fuels;
calculating a required input power percentage change required to change from the current input power to the input power required to operate the multi fuel engine at the desired engine speed;
comparing the required input power percentage change to a transient event input power percentage change; and
determining that the transient event is occurring if the required input power percentage change is greater than the transient event input power percentage change.

7. The method of claim 1, wherein one of the plurality of fuels is a gaseous fuel that is mixed with air prior to combustion in the multi fuel engine, and wherein the method comprises:
determining a current air fuel ratio of the gaseous fuel and the air; and
determining that the transient event is occurring if the current air fuel ratio is greater than a knock limit air fuel ratio.

8. The method of claim 1, wherein one of the plurality of fuels is a gaseous fuel that is mixed with air prior to combustion in the multi fuel engine, and wherein the method comprises:
receiving the desired engine speed;
determining the input power required to operate the multi fuel engine at the desired engine speed;
determining a desired engine speed air fuel ratio based on the specified fuel substitution ratio and the input power required to operate the multi fuel engine at the desired engine speed; and
determining that the transient event is occurring if the desired engine speed air fuel ratio is greater than a knock limit air fuel ratio.

9. The method of claim 1, wherein the transient event fuel substitution ratio is a specified transient event fuel substitution ratio.

10. The method of claim 1, wherein one of the plurality of fuels is a gaseous fuel that is mixed with air prior to combustion in the multi fuel engine, and wherein the method comprises:
receiving the desired engine speed;
determining the input power required to operate the multi fuel engine at the desired engine speed;
determining a knock limit fuel flow for the gaseous fuel based on an amount of air available for mixing with the gaseous fuel; and
determining a calculated transient event fuel substitution ratio based on the knock limit fuel flow and the input power required to operate the multi fuel engine at the desired engine speed.

11. An engine speed control system for a multi fuel engine, comprising:
an engine speed control configured to output an engine speed control signal indicating a desired engine speed;
a plurality of actuators, wherein each of the plurality of actuators corresponds to a fluid flow control device for one of a plurality of fuels that are available for providing power to the multi fuel engine by causing a flow of the corresponding one of the plurality of fuels to the multi fuel engine; and
a controller operatively connected to the engine speed control and the plurality of actuators, wherein:
the controller is configured to store a specified fuel substitution ratio for apportioning the plurality of fuels to the multi fuel engine,
the controller is configured to receive the engine speed control signal from the engine speed control,
the controller is configured to determine an input power for operating the multi fuel engine at the desired engine speed,
the controller is configured to determine whether a transient event is occurring at the multi fuel engine,
the controller is configured to output a fuel flow rate for each of the plurality of fuels to the one of the plurality of actuators of the fluid flow control device for the one of the plurality of fuels to cause the one of the plurality of actuators to provide the one of the plurality of fuels to the multi fuel engine according to the specified fuel substitution ratio in response to determining that the transient event is not occurring, and
the controller is configured to output a transient event fuel flow rate for each of the plurality of fuels to the one of the plurality of actuators of the fluid flow control device for the one of the plurality of fuels to cause the one of the plurality of actuators to provide the one of the plurality of fuels to the multi fuel engine according to a transient event fuel substitution ratio in response to determining that the transient event is occurring.

12. The engine speed control system of claim 11, wherein the controller is configured to determine whether the input power must change to operate the multi fuel engine at the desired engine speed before determining whether the transient event is occurring, to determine whether the transient event is occurring in response to determining that the input power must change, and to continue outputting the fuel flow rate for each of the plurality of fuels according to a current fuel substitution ratio in response to determining that the input power is not changing.

13. The engine speed control system of claim 11, comprising an engine speed sensor operatively connected to the controller and operatively coupled to the multi fuel engine to detect a measured engine speed of the multi fuel engine, wherein the engine speed sensor is configured to output a measured engine speed control signal indicating the measured engine speed, wherein the controller is configured to receive the measured engine speed control signal from the engine speed sensor, to determine a speed error equal to a difference between the desired engine speed and the measured engine speed, to compare the speed error to a transient event speed error value, and to determine that the transient event is occurring if the speed error is greater than the transient event speed error value.

14. The engine speed control system of claim 11, comprising an engine speed sensor operatively connected to the controller and operatively coupled to the multi fuel engine to detect a measured engine speed of the multi fuel engine, wherein the engine speed sensor is configured to output a measured engine speed control signal indicating the measured engine speed, wherein the controller is configured to receive the measured engine speed control signal from the engine speed sensor, to calculate a required engine speed percentage change required for the measured engine speed to be equal to the desired engine speed, to compare the required engine speed percentage change to a transient event engine speed percentage change, and to determine that the transient event is occurring if the required engine speed percentage change is greater than the transient event engine speed percentage change.

15. The engine speed control system of claim 11, wherein the controller is configured to determine a current input power provided to the multi fuel engine by the plurality of fuels, to determine an input power change equal to a difference between the input power required to operate the multi fuel engine at the desired engine speed and the current input power, to compare the input power change to a transient event gross input power change, and to determine that the transient event is occurring if the input power change is greater than the transient event gross input power change.

16. The engine speed control system of claim 11, wherein the controller is configured to determine a current input power provided to the multi fuel engine by the plurality of fuels, to calculate a required input power percentage change required to change from the current input power to the input power required to operate the multi fuel engine at the desired engine speed, to compare the required input power percentage change to a transient event input power percentage change, and to determine that the transient event is occurring if the required input power percentage change is greater than the transient event input power percentage change.

17. The engine speed control system of claim 11, wherein one of the plurality of fuels is a gaseous fuel that is mixed with air prior to combustion in the multi fuel engine, and wherein the controller is configured to determine a current air fuel ratio of the gaseous fuel and the air, and to determine that the transient event is occurring if the current air fuel ratio is greater than a knock limit air fuel ratio.

18. The engine speed control system of claim 11, wherein one of the plurality of fuels is a gaseous fuel that is mixed with air prior to combustion in the multi fuel engine, and wherein the controller is configured to determine a desired engine speed air fuel ratio based on the specified fuel substitution ratio and the input power required to operate the multi fuel engine at the desired engine speed, and to determine that the transient event is occurring if the desired engine speed air fuel ratio is greater than a knock limit air fuel ratio.

19. The engine speed control system of claim 11, wherein the controller is configured to store a specified transient event fuel substitution ratio.

20. The engine speed control system of claim 11, wherein one of the plurality of fuels is a gaseous fuel that is mixed with air prior to combustion in the multi fuel engine, and wherein the controller is configured to determine a knock limit fuel flow for the gaseous fuel based on an amount of air available for mixing with the gaseous fuel, and to determine a calculated transient event fuel substitution ratio based on the knock limit fuel flow and the input power required to operate the multi fuel engine at the desired engine speed.
